(19) United States
(12) Patent Application Publication
(10) Pub. No.: US 2011/0191771 A1
(43) Pub. Date: Aug. 4, 2011

(54) Feature Manager System for Facilitating Communication and Shared Functionality Among Components

(76) Inventor: Edward Balassanian, Seattle, WA (US)

(21) Appl. No.: 13/018,353

(22) Filed: Jan. 31, 2011

Related U.S. Application Data
(62) Division of application No. 11/599,785, filed on Nov. 15, 2006.
Application No. 11/599,785 is a continuation of application No. 09/688,581, filed on Oct. 16, 2000.

(51) Int. Cl. G06F 9/445

(52) U.S. Cl. 717/178; 717/176

(57) ABSTRACT

The feature manager system for facilitating communication and shared functionality among components comprises a network of components, where one component receives or generates a request for a feature, searches its local system for the feature, and if the feature is not available locally, sends a request to a server component in the network. The server component searches its local system for the feature, and either sends the feature to the requesting component, or sends a separate request for the feature to another server component in the network.

### FIELD

The present application is directed generally to a feature manager system for managing a computer network of components, and more particularly to a software configuration system for components that communicate and share functionality between each other.

### BACKGROUND

The Internet has created an entirely new world of features available to individuals with the appropriate hardware and software. Several new formats for accessing information, particularly sound, video and animation applications, have developed in parallel with other emerging Internet technologies. As such, users are constantly in need of specialized software to access these formats.

For example, an individual may wish to upgrade the web browser on a personal computer to acquire the ability to access different formats. In order to do so, the individual must access the appropriate web page and download the software upgrade to the personal computer with a plug-in or helper application. Alternatively, the individual accessing the Internet with a personal computer may attempt to open a file, such as a wave file, without a wave player available to the web browser of the personal computer. The web browser without a waveplayer does not recognize the wave file and possibly sends a help request to the web page containing the wave file. The web page containing the wave file then prompts the web browser to download the appropriate wave player software for accessing the wave file. If the individual agrees to download the software, the remote server controlling the web page accessed by the individual either downloads the software directly to the individual's personal computer, or transfers the individual to the appropriate web page for downloading the software. However, while browser plug-ins such as the wave player contain many resources, they are generally downloaded as a single archive (e.g., a zip file). Since the remote server downloading the wave player has no way to determine what resources the personal computer maintains locally, the remote server must transmit all of the resources required to run the wave player. Thus, even though some of the resources downloaded may be redundant to those resources already stored locally on the personal computer, all the resources of the wave player are downloaded as a single archive.

Also, one can generally only get browser plug-ins either by accessing a file (such as a wave file) that requires a browser plug-in (such as a wave player) and directs the individual to the browser plug-in web page, or by accessing that browser plug-in web page directly. There is no single and easy way to get a variety of browser plug-ins or other features from a central source.

Further, downloading each plug-in requires a separate download for each plug-in application, even though different plug-ins may share many of the same resources. Thus resources are stored duplicatively, wasting valuable memory on the computer.

### SUMMARY

The above identified problems are solved and a technical advance is achieved by the feature manager system for facilitating communication and shared functionality among components. In accordance with one aspect of the feature manager system, there is provided a method of deploying computer code for a feature within a network, comprising searching locally for the code for the feature, requesting the code for the feature from a server component in the network, receiving the code for the feature from the server component and activating the feature.

In accordance with another aspect of the feature manager system, there is provided a method of deploying computer code for a feature within a network, comprising receiving a request for the code for the feature from a first component within the network, searching locally for the code for the feature, requesting the code for the feature from a second component in the network, receiving the code for the feature requested from the second component, storing locally the code for the feature, and transferring the code for the feature to the first component within the network.

In accordance with yet another aspect of the feature manager system, there is provided a method of deploying computer code for a feature within a network, comprising receiving a request for the code for the feature from a component within the network, searching locally for the code for the feature, and transferring the code for the feature to the component within the network.

An advantage of the feature manager system is upon receipt of a request for the code for a feature from a component in the network, the component receiving the request determines whether the component sending the request has the capability to process any or all of the sub-features of the feature.

Further aspects of the feature manager system for facilitating communication and shared functionality among components will become apparent during the course of the following detailed description and by reference to the attached drawings.

### BRIEF DESCRIPTION OF THE DRAWINGS

The accompanying drawings illustrate certain aspects of the feature manager system for facilitating communication and shared functionality among components:

FIG. 1 is a diagram of a client-server hierarchy in accordance with the instant application;

FIG. 2 is an exemplary block diagram illustrating a feature manager system;

FIG. 3 is an exemplary proxiworld knowledge table stored in a personal computer of FIGS. 1 and 2;

FIG. 4 is an exemplary proxiworld knowledge table stored in the local area network server of FIG. 2;

FIG. 5 is an exemplary resource file registry stored in an end appliance of FIGS. 1 and 2;

FIG. 6 is an exemplary resource file registry stored in a personal computer of FIGS. 1 and 2;

FIG. 7 is an exemplary feature description table stored in an end appliance of FIGS. 1 and 2;

FIGS. 8A-B are a flow chart of an exemplary feature request and fulfillment process for the feature manager system;

FIG. 9 is a block diagram illustrating the processing of the conversion system of the mapping process;

FIG. 10 is a block diagram illustrating an exemplary path; and

FIG. 11 is a block diagram illustrating the components of the conversion system.

It will be understood that the foregoing brief description and the following detailed description are exemplary and explanatory of the feature manager system, but are not intended to be restrictive thereof or limiting of the advantages which can be achieved by the feature manager system.

### DETAILED DESCRIPTION

The feature manager system of the instant application comprises a number of components in a network. Each component maintains a feature manager, which communicates with other feature managers in the network about feature requests and feature transfers. As used herein, a feature is defined as software or computer code that provides functionality to a component. An example of a feature is an MP3 player. Features are often made up of sub-features, which are features themselves, but work together in the feature manager system to create a separate feature. Feature managers store information about other components they communicate directly with, and about features available locally. Feature managers rely on this information during the feature request and fulfillment process. This process is initiated by a request or other system decision. A component feature manager then determines if a feature is available locally, and if not, the component feature manager requests the feature from another component feature manager in the system.

For example, an individual using a personal digital assistant (PDA) may request a telephone feature from a personal computer (PC) located inside that individual's home. While the individual wants a telephone, the PC feature manager translates the request to a request for a microphone, speaker and remote data connection (i.e., sub-features of the telephone feature). The PC feature manager first checks for these sub-features within its own system, and if some or all of them are not found, the PC feature manager requests the missing sub-features from another feature manager in the system.

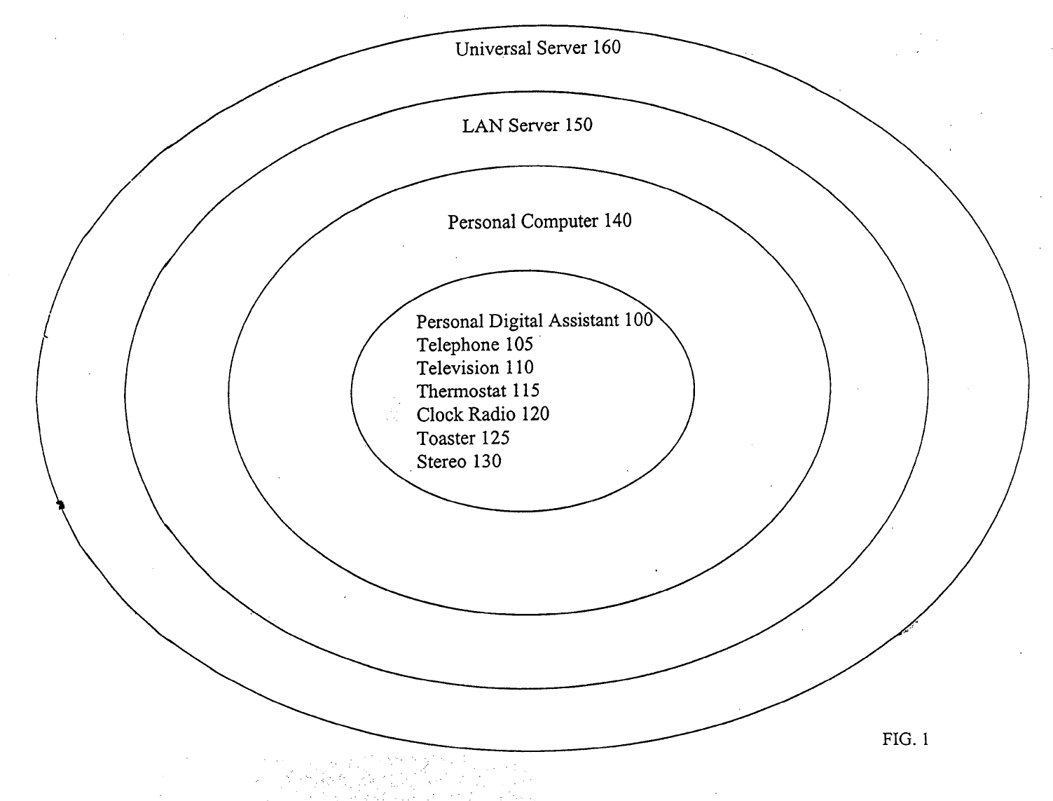

The system is illustrated generally in FIG. 1. Feature manager operations are based on a client-server hierarchy. For instance, in one embodiment, the lowest level in the hierarchy is the end appliance level, such as a personal PDA 100, telephone 105, television 110, thermostat 115, clock radio 120, toaster 125 and stereo 130. These end appliances have no level below them, and the feature manager configured within each end appliance can only communicate “up” to the next level in the hierarchy, illustrated in FIG. 1 as a personal computer (PC) 140. Each end appliance feature manager can assume control of another device (i.e., a client), thus assuming a level above the bottom of the hierarchy. In the embodiment illustrated in FIG. 1, the PC 140 feature manager acts as the server, and each end appliance is a client to the PC 140. Thus, any requests for a feature from any of the end appliances go directly to the PC 140 feature manager.

The feature manager hierarchy continues upward from the PC 140 to the local area network (LAN) server 150. The LAN server 150 feature manager acts as the server (in the client-server relationship) to at least one PC (i.e., PC 140), and in other embodiments, multiple PCs that are part of a local area network. These multiple PCs are clients to the LAN server 150. The PC 140 feature manager may communicate “down” one level to any of the end appliance feature managers, or it may communicate “up” to the feature manager LAN server 150, where the PC 140 feature manager serves as the “client” to the LAN server 150. For example, in one embodiment, an end appliance, such as the PDA 100, may request a feature from the PC 140 feature manager. However, the PC 140 feature manager may determine that it does not have that feature stored locally. The PC 140 feature manager then looks “up” to the next level, and requests the feature from the LAN server 150 feature manager. If the LAN server 150 feature manager has the feature stored locally, in one embodiment, the LAN server 150 transfers the feature to the PC 140 feature manager. The PC 140 feature manager then stores the feature locally, and transfers the feature to the end appliance feature manager to satisfy the request.

In one embodiment, the highest level in the feature manager hierarchy is the universal server 160. The universal server 160 generally stores within its local system all features any client (i.e., end appliance, PC, LAN server, etc.) may request. For instance, if an end appliance feature manager requests a feature from the PC feature manager, and the PC feature manager determines that it cannot get that feature from its local system, the PC feature manager then requests the feature up the ladder. Ultimately, if the feature is somewhere, it will be stored at the universal server 160. If the feature is transferred “down” the hierarchy from the universal server 160 to an end appliance, at each level, that feature is stored locally for future requests and use. For instance, the LAN server 150 feature manager and the PC 140 feature manager will both store locally a feature being sent “down” from the universal server 160 to an end appliance.

In one embodiment, the client feature manager only communicates with a feature manager at an immediately adjacent level above or below, assuming that feature manager acts as both a client to the feature manager at the adjacent level above, and a server to the adjacent level below. The client feature manager cannot communicate with other feature managers at the same level as itself, nor can it communicate outside the chain of the feature manager hierarchy (i.e., at levels other than directly above or below itself). For instance, in the embodiment illustrated in FIG. 1, the PDA 100 feature manager can only communicate with the PC 140 feature manager. The PDA 100 feature manager cannot communicate with other end appliance feature managers, such as the telephone 105, nor can it communicate with the LAN server 150 feature manager, unless indirectly through the PC 140 feature manager. For example, if the PDA 100 feature manager requests a feature from the PC 140 feature manager, and the PC 140 feature manager does not have access to the feature locally, the PC 140 feature manager forwards the request to the LAN server 150 feature manager. However, if the LAN server 150 feature manager has the feature stored locally, it does not send the feature directly to the PDA 100 feature manager, but instead sends the feature to the PC 140 feature manager, which stores the feature to its local system, and then, in one embodiment, transfers the feature to the PDA 100 feature manager.

The feature manager system is not limited to this communication restriction, and in other embodiments, communications between all feature managers within the system is allowed.

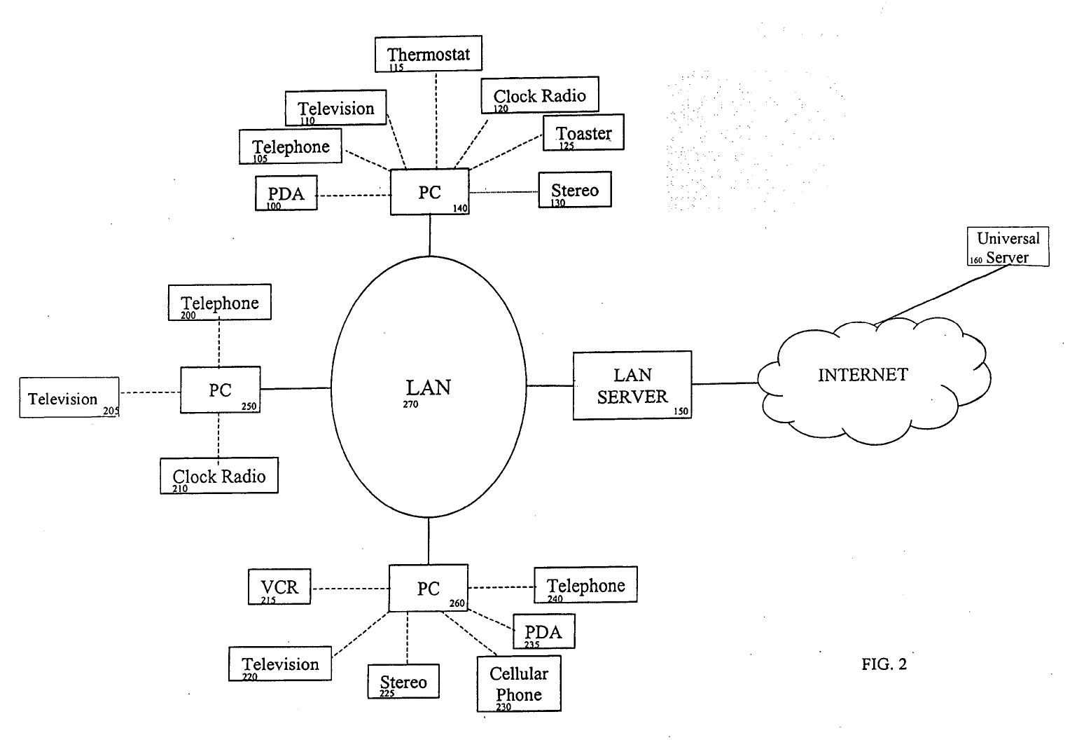

FIG. 2 illustrates a system of components, each of which includes a feature manager that communicates based on the hierarchy described above. For example, the PDA 100, telephone 105, television 110, thermostat 115, clock radio 120, toaster 125 and stereo 130 are all end appliances that are clients to the PC 140. In other words, any feature request from one of these end appliance feature managers is sent to the PC 140 feature manager.

Other end appliances are illustrated in FIG. 2 as reporting to other PCs. For example, a telephone 200, television 205, and clock radio 210 report to a PC 250, and a VCR 215, television 220, stereo 225, cellular phone 230, PDA 235 and telephone 240 report to a PC 260. Further, the PCs 140, 250 and 260 are part of a local area network, which is managed by the LAN server 150. Again, any requests for features from the PC feature managers go “up” to the LAN server 150 feature manager. Finally, as illustrated in FIG. 2, the universal server 160 is accessible to the LAN server 150 through the Internet. Thus, in one embodiment, any requests from a LAN server feature manager go to the universal server by means of the Internet.

The feature manager system is not limited to the embodiment illustrated in FIGS. 1 and 2, and may include multiple additional levels of components within the feature manager hierarchy.

The feature manager system relies on feature managers within each component in the system that communicate with each other through a “mapping” process based on protocols, described in detail below as well as in U.S. patent application Ser. No. 09/304,973 entitled “Method and System For Generating A Mapping Between Types of Data”, incorporated herein by reference.

In one embodiment, features are requested by certain components and stored in other components within the feature manager system. For example, a PDA may request an MP3 player, wave player, and a web browser. All are features that are available somewhere within the feature manager hierarchy. However, as described in detail below, the PDA may not have the capability to receive every feature the PDA requests. Within the feature manager system, each feature manager becomes aware of the capabilities of other components it communicates with directly, and feature managers make decisions based on this knowledge. For instance, in the example described above, the PDA may not have the processing capability to accept and store the MP3 player feature. The feature manager that receives the request for the MP3 player feature from the PDA feature manager is aware of this restriction, and, as described in detail below, makes decisions based on such.

Also, different versions of the same feature may exist throughout the system. For example, a group of features may exist that perform the same function. However, one version may be more sophisticated than another, more or less expensive, contain more or less computer code or require more or less memory space or processing power, etc. In one embodiment, each feature is rated or certified based on different factors such as mentioned above that comprise the feature. When multiple versions of the same feature exist, feature managers make decisions regarding which version of the feature to send based either on the capability of the requesting component to accept the feature, or requirements imposed by the request itself. For example, a user can set general requirements that the feature manager responding to the request can attempt to satisfy. Also, the user can set specific requirements, such as fastest feature available, least expensive, etc. For instance, a PDA requesting an MP3 player may also request the least expensive MP3 player available. The feature manager responding to this request determines if an MP3 player feature is available, and if multiple versions of the MP3 player feature are available, the feature manager determines the least expensive MP3 player (i.e., based on its rating or certification) and sends it to the PDA.

Features are generally requested by and delivered to components (i.e., an end appliance) that make the feature available to a user. Many features are made up of sub-features, which are features themselves, but function together to create a separate feature. For example, an MP3 player is a feature that may be requested by an end appliance, such as a PDA. However, in one embodiment, the MP3 player is made up of an MP3 decoder and a PCM player. Both the MP3 decoder and the PCM player are features themselves, but in this example, they are sub-features that work together to make up the MP3 player feature. A feature may comprise several sub-features that, as described in detail below, may be distributed by the feature manager system throughout different components to satisfy a feature request.

A sub-feature may be used with multiple features. For example, an end appliance feature manager may request two features that share one or more sub-features. Both the requesting feature manager and the feature manager that satisfies the request know that certain sub-features are shared, and manage the transfer of sub-features efficiently based on this knowledge. For example, a PDA feature manager may request both an MP3 player feature and a wave player feature. Since the feature manager providing the features knows that both the MP3 player and the wave player use a PCM player (i.e., a shared sub-feature), the feature manager providing the features only downloads the PCM player once to the requesting feature manager. Alternatively, if the PDA feature manager first requested the MP3 player feature, and later requested the wave player feature, the PDA feature manager requesting the features knows that the PCM player sub-feature was already provided as part of the MP3 player feature request, and relies on that same PCM sub-feature already provided to satisfy that portion of the wave player feature request.

Further, based on such sharing of sub-features [and other resources (i.e., protocols) identified in the “mapping” patent application and described below], the feature manager system allows other features to be upgraded when one sub-feature or other resource is upgraded. For example, if a feature manager decides to upgrade a sub-feature that makes up a feature at a level below in the system, such an upgrade affects not only that feature, but any other feature at that lower level that also relies on that “shared” sub-feature. In fact, the feature manager that receives the sub-feature upgrade can transfer that upgraded sub-feature down to the next level, and each respective feature manager can them transfer the upgraded sub-feature down to the next level, as the system allows.

### Proxiworld Knowledge Tables

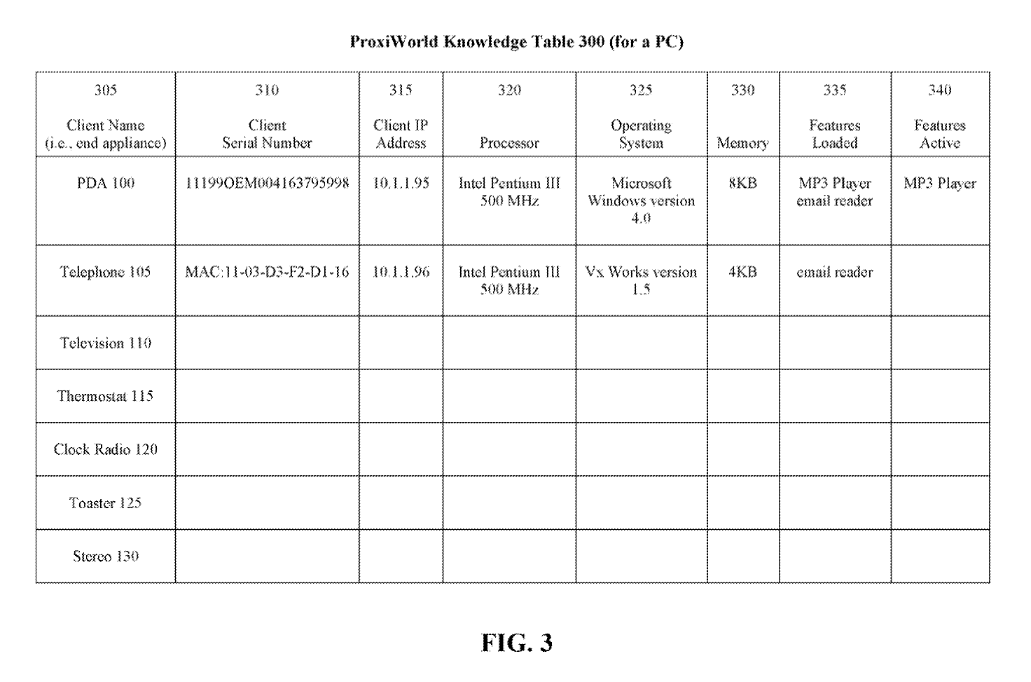

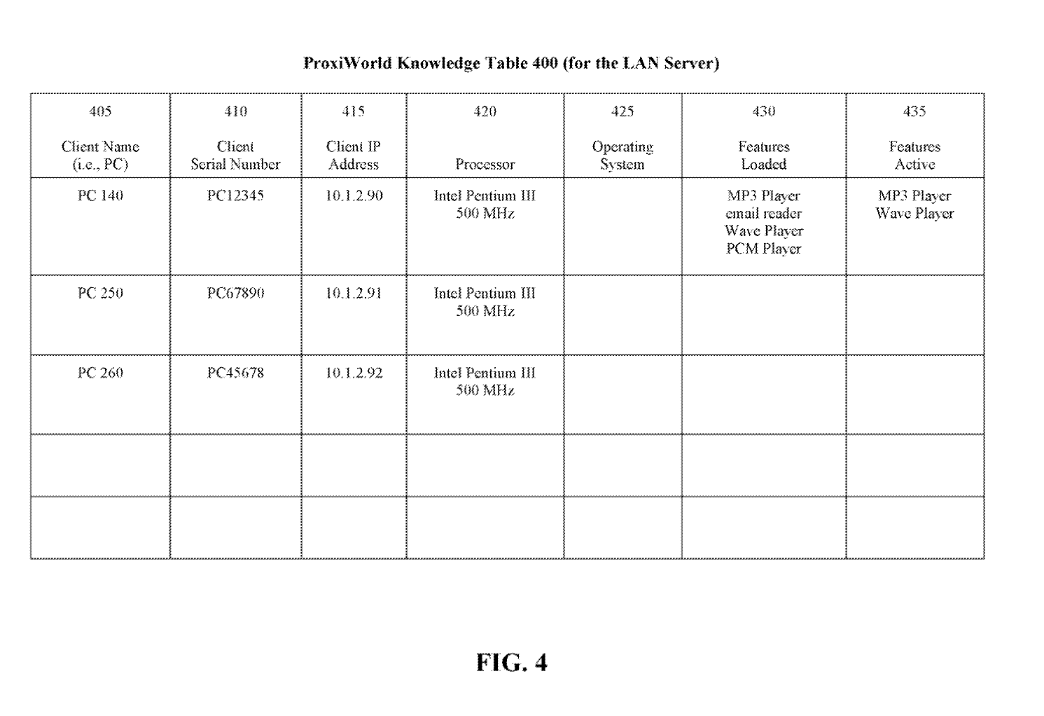

An exemplary proxiworld knowledge table for a PC and a LAN server is shown in FIGS. 3 and 4, respectively. The specific data and fields illustrated in those figures represent only one embodiment of the proxiworld knowledge information stored in components of the feature manager system. In most cases, the exemplary fields shown in FIGS. 3 and 4 are relatively self-explanatory. The specific data and fields illustrated in those figures, as well as the number of proxiworld knowledge tables, can be readily modified from the described exemplary embodiment and adapted to provide variations for proxiworld knowledge. Furthermore, each field may contain more or less information.

Generally, a proxiworld comprises the directly adjacent lower level of clients for the server (in the client-server relationship described earlier) within the feature manager hierarchy. For example, as illustrated in FIG. 2, the PC 140 proxiworld consists of the PDA 100, telephone 105, television 110, thermostat 115, clock radio 120, toaster 125 and stereo 130. Since each of these components is an end appliance and has no “clients” or lower level, each proxiworld is empty.

The proxiworld knowledge table stores information about each client within the proxiworld. Thus, the end appliances described above that are clients to the PC 140 in FIG. 2 maintain proxiworld knowledge tables, although they are empty. However, each end appliance may become a “server” with responsibility to clients, in which case their proxiworld knowledge table would fill up with information about each client.

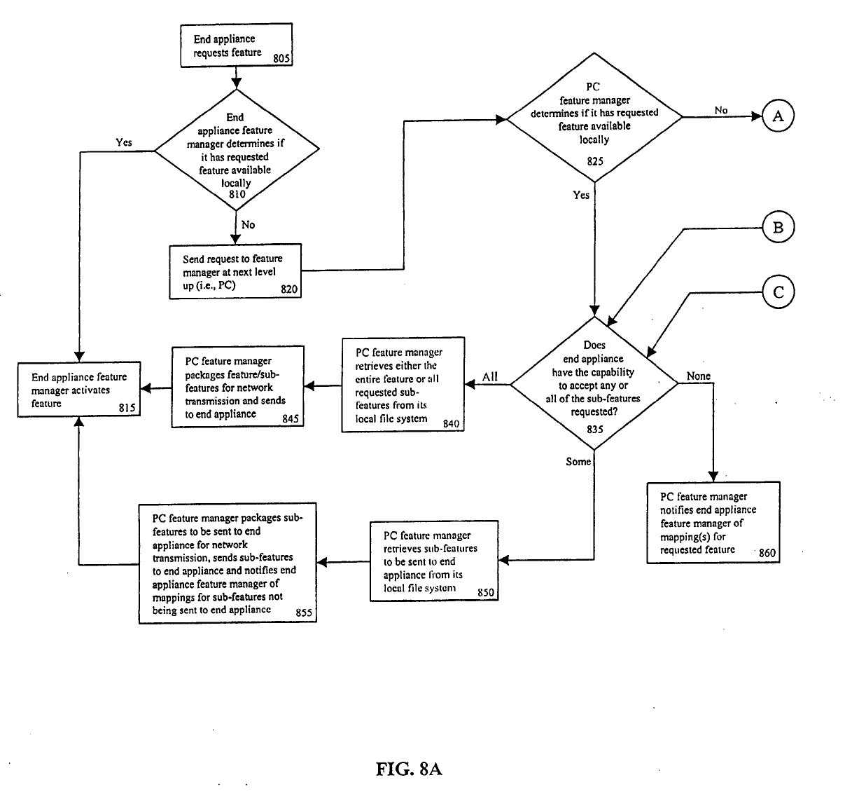

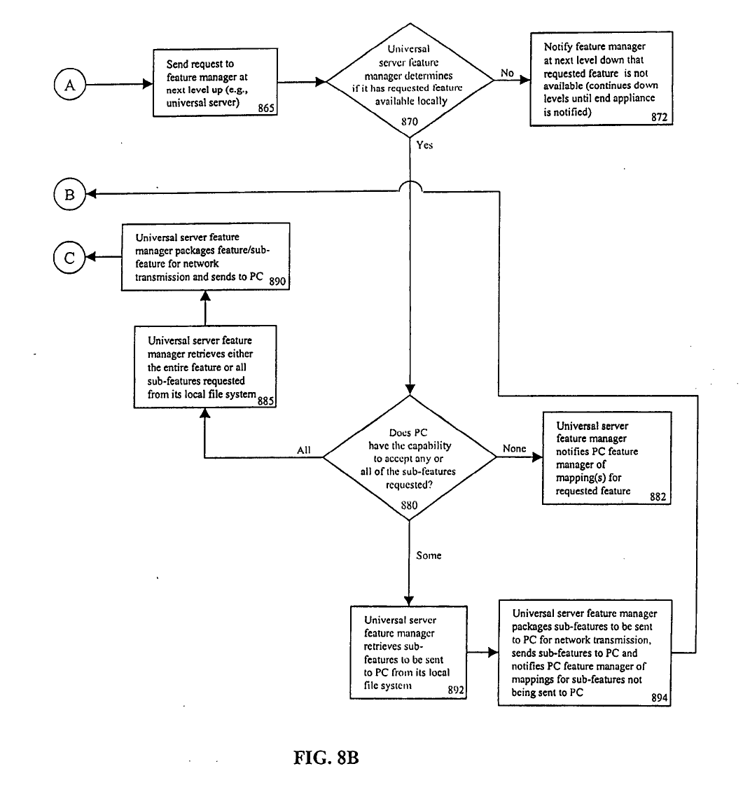

Proxiworld Knowledge Table 300 is shown in FIG. 3 for a PC, such as the PC 140 illustrated in FIG. 2, and maintains (among other information) a compilation of information about each client that reports to the PC. Each record in Proxiworld Knowledge Table 300 corresponds to one client (i.e., one end appliance that reports to the PC). As shown in FIG. 3, Proxiworld Knowledge Table 300 contains fields corresponding to, for example, client name 305, client serial number 310, client IP address 315, processor 320, operating system 325, memory 330, features loaded 335, and features active 340. The client serial number 310 is an alphanumeric identifier for the client/end appliance. The client IP address 315 is the Internet Protocol (IP) address for the client/end appliance. The processor field 320 identifies the type of processor used by the client, including the processing speed. Thus, this is one piece of information the “server” evaluates to determine if a “client” can handle a particular feature. For example, the PDA 100 feature manager may request an MP3 player feature from the PC 140 feature manager. However, the PC 140 feature manager looks at the processing capability of the PDA's processor, and may determine that the PDA 100 does not have the processing capability to accept the MP3 player feature. The PC 140 feature manager considers alternate options, described in detail below in connection with FIGS. 8A-B.

The operating system field 325 identifies the operating system used by the client/end appliance, and the memory field 330 identifies the memory capacity available for the client/end appliance. Both fields are additional factors the “server” evaluates to determine if a “client” can handle a particular feature.

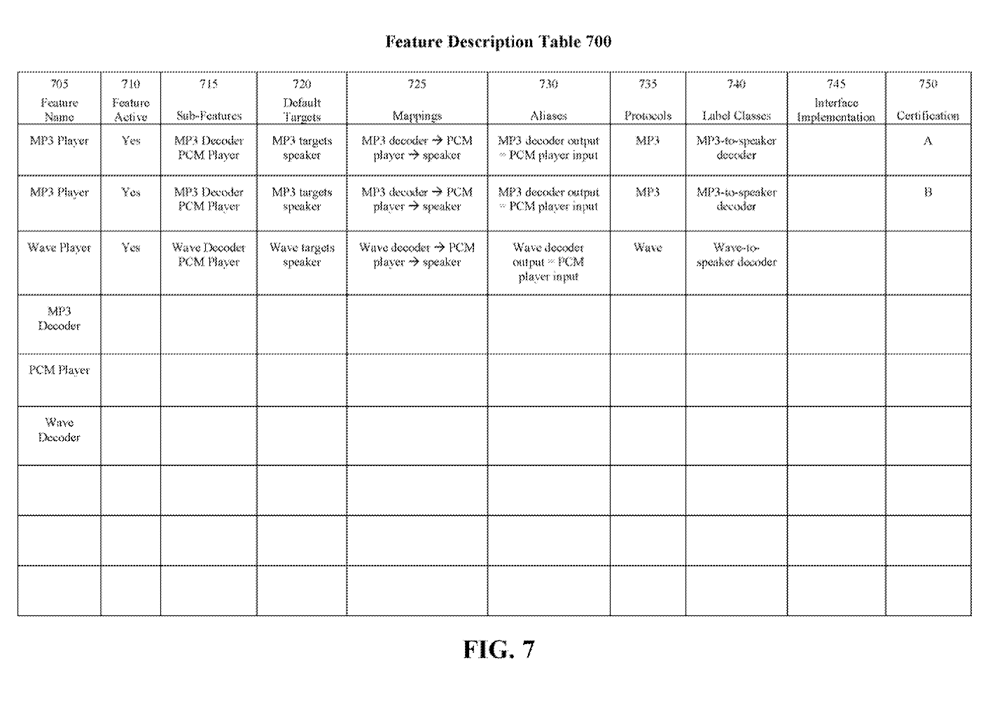

The field 335 entitled “Features Loaded” identifies the particular features that were downloaded at one time to the client/end appliance, and are available to be activated. Features are activated by downloading the necessary protocols, label classes, mappings, aliases, and default targets, described below in connection with FIG. 7. As a result, activated features consume more resources than those that are merely loaded. Each component feature manager uses an initialization file that saves to memory all features downloaded and active when the system is running. Assuming a system shutdown, upon re-boot, the initialization file that saved the feature information informs the feature manager which features were active prior to the most recent shutdown and re-boot/start-up. The feature manager again activates the same features. However, additional features may be activated at the discretion of the feature manager. The “Features Loaded” field 335 includes all features available to the client, regardless of whether or not they have been activated. The “Features Active” field 340 identifies the features that are active at that time.

Proxiworld Knowledge Table 400 is shown in FIG. 4 for a LAN server, such as the LAN server 150 illustrated in FIG. 2, and maintains (among other information) a compilation of information about each client that reports to the LAN server (for this table, each client is a PC that is part of a local area network controlled by a LAN server, such as the PC's 140, 250 and 260 within local area network 270 and controlled by LAN server 150, as illustrated in FIG. 2). Each record in Proxiworld Knowledge Table 400 corresponds to one client (i.e., each PC that “reports” to the LAN server). As shown in FIG. 4, Proxiworld Knowledge Table 400 contains fields corresponding to, for example, client name 405, client serial number 410, client IP address 415, processor 420, operating system 425, features loaded 430, and features active 435. Each field in Proxiworld Knowledge Table 400 is identical to the fields in Proxiworld Knowledge Table 300.

Every component in the feature manager system maintains a proxiworld knowledge table, including the universal server 160 illustrated in FIG. 2. Such proxiworld knowledge tables allow the feature manager within each component to make efficient decisions regarding feature transmission throughout the feature manager hierarchy.

### Resource File Registry

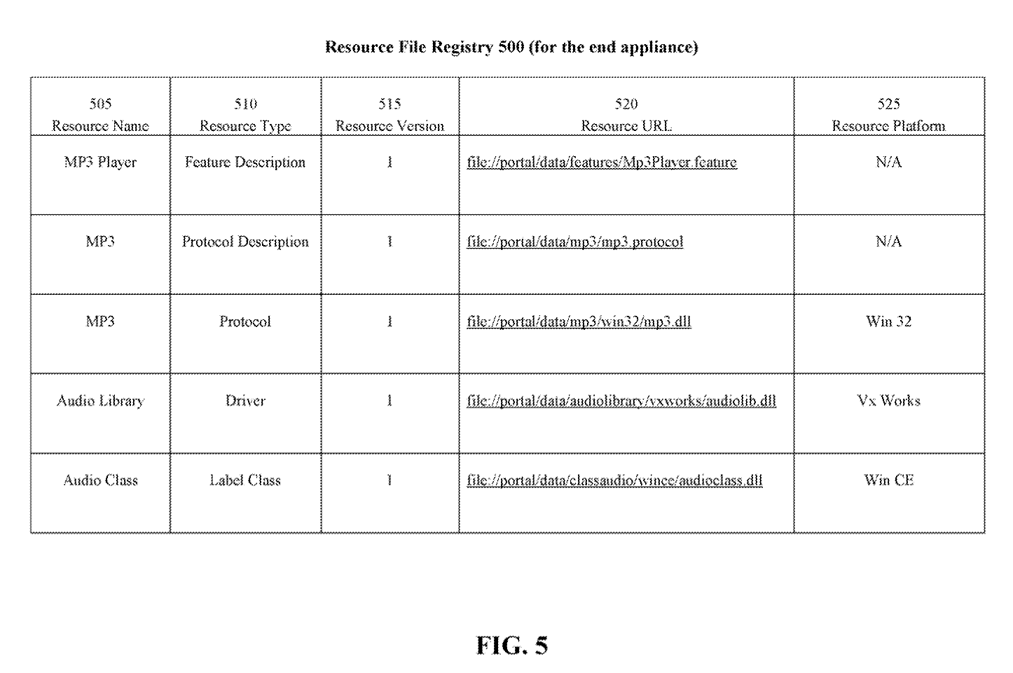

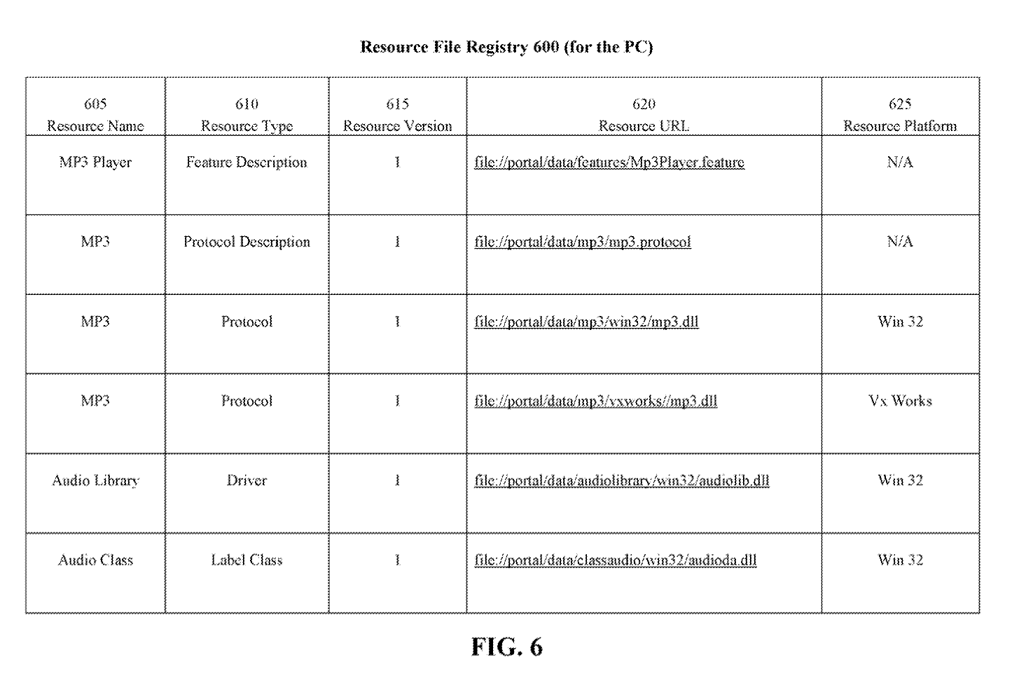

An exemplary resource file registry for an end appliance and a PC is shown in FIGS. 5 and 6, respectively. The specific data and fields illustrated in those figures represent only one embodiment of the resource information stored in components of the feature manager system. In most cases, the exemplary fields shown in FIGS. 5 and 6 are relatively self-explanatory. The specific data and fields illustrated in those figures, as well as the number of resource file registries, can be readily modified from the described exemplary embodiment and adapted to provide variations for resource information. Furthermore, each field may contain additional information.

A resource is a generic term that comprises several ideas that are fundamentally explained in the mapping patent application, incorporated earlier by reference and described in detail below. Resources include feature description files, as well as other items, such as protocols, drivers and label classes. However, a feature is not a resource, but a collection of resources. Certain resources are important for delivering a feature from one component feature manager to another. Thus, each component feature manager maintains a resource file registry to monitor each resource stored within its local system.

Resource File Registry 500 is shown in FIG. 5 for an end appliance, such as the PDA 100 illustrated in FIG. 2, and maintains (among other information) a compilation of information about each resource locally available to the end appliance. Each record in Resource File Registry 500 corresponds to one resource. As shown in FIG. 5, Resource File Registry 500 contains fields corresponding to, for example, resource name 505, resource type 510, resource version 515, resource URL 520 and resource platform 525. The resource name 505 is the name attached to the particular resource by the system. In one embodiment, the resource name is an alphanumeric string. Resources are generally requested within the feature manager system by resource name. The resource type 510 indicates the type of resource, and includes feature description, protocol description, protocol and driver, among others. In one embodiment, description files are text files that describe the resource and provide other information about the resource, such as configuration and download information. A feature itself is never an entry in a resource file registry (because, as described above, a feature is a collection of resources), but a feature description is found in a resource file registry.

The field 520 entitled “Resource URL” is the Uniform Resource Locator (URL) for the resource. In one embodiment, the Resource URL is a local URL, beginning with the prefix “file://”. In this embodiment, the feature manager does not consider any files in a remote location to be part of that feature manager's registry. If the feature manager does not have access to a resource locally, the feature manager requests the resource from its server (in the feature manager hierarchy) rather than maintaining remote access to the resource.

The field 525 entitled “Resource Platform” is generally applicable to certain resource types (i.e., protocol, label class, or driver), and indicates the type of platform the resource uses. In one embodiment, supported values include “Win 32” (Microsoft Windows), “Vx Works”, and “Win CE” (Microsoft Windows CE).

Resource File Registry 600 is shown in FIG. 6 for a PC, such as the PC 140 illustrated in FIG. 2, and also maintains (among other information) a compilation of information about each resource locally available to the PC. Each field in the Resource File Registry 600 is identical to the fields in Resource File Registry 500, except the resource file registry is for the PC, as opposed to the end appliance. As shown in FIG. 6, the protocol resource named “MP3” maintains two entries in Resource File Registry 600. The only differences between the two entries are the Resource URL and Resource Platform. The first MP3 protocol entry maintains a “Win 32” platform, with a corresponding resource URL (file:///portal/data/mp3/win32/mp3.dll), and the second MP3 protocol entry maintains a “Vx Works” platform, also with a corresponding resource URL (file:///portal/data/mp3/vxworks/wp3.dll). For the PC feature manager that maintains the Resource File Registry 600, the same MP3 protocol is available to the PC feature manager through two separate platforms.

Every component in the feature manager system maintains a resource file registry, including the LAN server 150 and universal server 160 illustrated in FIG. 2. Each resource file registry allows the feature manager within each component to know what resources are available locally.

### Feature Description Tables

An exemplary feature description table is shown in FIG. 7. The specific data and fields illustrated in this figure represent only one embodiment of feature information stored for a component of the feature manager system. In most cases, the exemplary fields shown in FIG. 7 are relatively self-explanatory. The specific data and fields illustrated in this figure, as well as the number of feature description tables, can be readily modified from the described exemplary embodiment and adapted to provide variations for feature information. Furthermore, each field may contain more or less information.

The feature manager for each component in the feature manager system includes a feature description table. The table provides specific information about each feature loaded for that particular component. For example, any feature included in the “Features Loaded” field of the proxiworld knowledge table for that component, and included in the resource file registry as a “feature description” in the “Resource Type” field is a record in the feature description table. The feature description table includes information used by the system described in the mapping patent application, incorporated earlier by reference, for mapping the feature.

Feature Description Table 700 is shown in FIG. 7 for an end appliance, such as the PDA 100 illustrated in FIG. 2, and maintains (among other information) a compilation of information about each feature loaded on the end appliance. Each record in the Feature Description Table 700 corresponds to one feature. As shown in FIG. 7, Feature Description Table 700 contains fields corresponding to, for example, feature name 705, feature active 710, sub-features 715, default targets 720, mappings 725, aliases 730, protocols 735, label classes 740, interface implementations 745 and certification 750.

The feature active field 710 indicates whether the feature is active. The sub-features field 715 contains all sub-features that make up the feature. For example, as described above, the MP3 player feature is made up of an MP3 decoder sub-feature and a PCM player sub-feature. Both sub-features (i.e., the MP3 decoder and PCM player) are features themselves, and also have their own record in the Feature Description Table 700. Storage of the sub-feature information by the feature description table allows the feature manager to make efficient feature request decisions and determine the impact of a sub-feature upgrade on multiple features that share that sub-feature.

The field 720 entitled “Default Targets” indicates the final destination where the data which the feature concerns is mapped. The field 725 entitled “Mappings” indicates the preferred way to route the data which concerns the feature. The field 730 entitled “Aliases” identifies labels that can be substituted for other labels while mapping the data concerning the feature. The field 735 entitled “Protocols” identifies the recognized parts of a path for the feature. The field 740 entitled “Label Classes” identifies alternate naming schemes used during the mapping process. The field 745 entitled “Interface Implementations” identifies “mediators” that allow the protocols to communicate with platform-specific items such as speakers and file systems.

Finally, the certification field 750 distinguishes multiple versions of the same feature. For example, in one embodiment, a letter rating (i.e., “A”, “B”, or “C”) is provided based on the cost of the feature. However, in other embodiments, the rating may be in other formats and based on other criteria.

The feature request and fulfillment process using data from the proxiworld knowledge tables, resource tables, and feature description tables is illustrated in connection with the flow chart of FIGS. 8A-B.

### Feature Request and Fulfillment Process

The feature request and fulfillment process involves a series of steps where, based on a request or a system determination, each relevant component feature manager in the system determines the availability of a feature locally, and communicates between component feature managers throughout the system to find and deliver the feature to a requesting or targeted component feature manager. The steps illustrated in FIGS. 8A-B start with an end appliance requesting a feature, and move up the feature manager hierarchy ultimately to the universal server. However, a feature request may initiate at any level in the feature manager hierarchy, as described in detail below.

As shown in FIGS. 8A-B, the first step comprises an end appliance, such as the PDA 100 illustrated in FIG. 2, requesting a feature such as an MP3player (step 805). The request may be initiated a number of different ways. For example, in one embodiment, an individual using an end appliance may request from the end appliance the use of a particular feature, such as an MP3 player. In another embodiment, a component feature manager may determine, based on certain information, that it needs a particular feature, such as an MP3 player. Further, in yet another embodiment, a “server” (in the client-server relationship discussed earlier), such as a PC, may determine, based on certain information, that one of its clients, such as the PDA, needs a particular feature. Finally, in another embodiment, the universal server may download a new feature and determine that the feature should be sent to certain clients throughout the system. Those clients may decide whether to send the feature to their clients, etc., following the feature manager hierarchy described earlier.

Next, the end appliance feature manager determines if it has the requested feature available locally (step 810). In one embodiment, the end appliance feature manager reviews its resource file registry (such as the Resource File Registry 500 illustrated in FIG. 5) to determine if the feature exists locally. In another embodiment, the end appliance feature manager reviews its feature description table (such as the Feature Description Table 700 illustrated in FIG. 7) to determine if the feature exists locally. If the feature is found locally, the end appliance feature manager determines if the feature is active by referring to the “Feature Active” field in the feature description table. If the feature is not active, the end appliance feature manager activates the feature, by loading the necessary protocols, label classes, mappings, aliases and default targets (step 815). As described earlier, the feature manager initialization file identifies which features are active at that time, and those same features are re-activated the next time the system is re-booted.

If the feature is not available locally, the end appliance feature manager sends a request for the feature to the next level “up” the feature manager hierarchy, which, as illustrated in FIGS. 8A-B, is directed to a PC (step 820). The PC feature manager receives the request, and, in one embodiment, determines if the requested feature is made up of multiple sub-features. The PC feature manager may have this information available in its feature description table, or it may retrieve this information from another feature manager in the hierarchy. If the requested feature is not made up of multiple sub-features, the PC feature manager determines if it has the requested feature available locally as described in detail below in connection with step 825. However, if the requested feature is made up of multiple sub-features, the PC feature manager reports this information back to the end appliance feature manager. The end appliance feature manager then determines if it has any of the sub-features that make up the feature available locally. The end appliance feature manager again reviews its resource file registry to determine if any or all of the sub-features that make up the feature exist locally. If all of the sub-features that make up the feature are available locally, the end appliance feature manager fulfills the feature request by activating those sub-features.

For example, an end appliance feature manager, after receiving a request for an MP3 player, determines that it does not have the MP3 player feature available locally. However, after requesting the MP3 player feature from the PC feature manager, the PC feature manager reports back to the end appliance feature manager that the MP3 player feature is made up of an MP3 decoder sub-feature and a PCM player sub-feature. The end appliance feature manager then determines it has both sub-features (e.g., the MP3 decoder and the PCM player) available locally, and fulfills the feature request by activating those sub-features.

If other than all of the sub-features that make up the feature are available locally, the end appliance feature manager again sends a request to the PC feature manager. This request is based on the end appliance feature manager's local search for any sub-features that make up the requested feature. If some of the sub-features that make up the requested feature are available locally, the request submitted by the end appliance feature manager takes this into account and only requests the sub-features not available locally to the end appliance feature manager. However, if none of the sub-features that make up the feature are available locally, the end appliance feature manager again requests the original requested feature itself from the PC feature manager.

For example, if an end appliance feature manager is unable to satisfy an MP3 player feature request locally, after determining from the PC feature manager the sub-features that make up the MP3 player feature, the end appliance feature manager reviews its feature description table to determine if it has any sub-features that make up the MP3 player feature. Based on the knowledge that an MP3 player feature is made up of an MP3 decoder sub-feature and a PCM player sub-feature, the end appliance feature manager determines that the end appliance has the PCM player sub-feature available locally. As a result, the end appliance feature manager requests only the MP3 decoder from the PC feature manager to satisfy the MP3 player request.

The PC feature manager receives the request and determines if it has the requested feature or sub-feature(s) available locally (step 825). Again, in one embodiment, the PC feature manager reviews its resource file registry to determine if the requested feature or sub-feature(s) exists locally.

If the feature or sub-feature(s) is found locally by the PC feature manager, the PC feature manager evaluates the end appliance record in the PC feature manager proxiworld knowledge table to determine if the end appliance has the processing capability, memory or appropriate operating system to receive some or all of the requested features/sub-features (step 835). For the example described above, the PC feature manager may determine from its proxiworld knowledge table that the end appliance processor does not have the capability to receive and activate the MP3 decoder sub-feature. Thus, the PC feature manager may send an alternate response, such as providing a remote decoding version of the MP3 player feature to the end appliance feature manager.

Also, in another embodiment, the PC feature manager may locate multiple versions of the same feature requested by the end appliance feature manager. Based on the capability evaluation, the PC feature manager may determine that the end appliance feature manager only has the capability to receive certain of the available versions. Also, the end appliance feature manager may include general or special request instructions that either limit the feature to be received generally based on a number of requirements, or specifically based on one or more of the following—cost, memory, processing speed, etc. Thus, based on this information, the PC feature manager can best determine which version of the feature to send to the end appliance feature manager.

After the PC feature manager completes this capability evaluation, it generally proceeds in one of three ways. First, if the PC feature manager determines that the end appliance has the capability to receive, activate and use the feature/sub-feature(s) necessary to fulfill the request, the PC feature manager retrieves the necessary feature/sub-feature(s) locally (step 840), packages the feature/sub-feature(s) for network transmission and sends to the end appliance (step 845). In one embodiment, the feature/sub-feature(s) are encrypted when transferred to the end appliance for security purposes, and all other transfers throughout the system are encrypted as well. In another embodiment, the feature/sub-feature(s) use a digital signature when transferred to the end appliance, also for security purposes, and all other transfers throughout the system rely on a digital signature as well.

Upon receipt of the feature/sub-feature(s), the end appliance activates the feature as described earlier in connection with step 815.

Second, the PC feature manager may determine that the end appliance only has the capability to receive certain sub-features requested, but not all sub-features requested. In that case, the PC feature manager retrieves the sub-features the end appliance has the capability to accept from the PC local file system (step 850), packages the sub-features for network transmission and sends to the end appliance. The PC feature manager also communicates to the end appliance feature manager that use of the requested feature requires coordination with the PC feature manager, because the end appliance does not have the capability to accept or use the requested feature/sub-feature(s) by itself. The PC feature manager notifies the end appliance feature manager of the mappings for sub-features not being sent to the end appliance. Also, the PC feature manager activates those sub-features that the end appliance feature manager receives a mapping for (if they were not already active) (step 855).

For example, if an end appliance feature manager, in response to a request for an MP3 player feature, requests the MP3 decoder sub-feature from the PC feature manager (because it has a PCM player sub-feature already loaded), but does not have the capability to accept the MP3 decoder sub-feature, the PC feature manager directs the end appliance feature manager to rely on the MP3 decoder sub-feature loaded and activated at the PC to fulfill that portion of the MP3 player feature. Thus, while the end appliance does not have the capability to load the MP3 decoder, the end appliance can rely on the MP3 decoder stored locally at the PC, as arranged by both the PC feature manager and the end appliance feature manager. Further, to an individual using the feature, it is transparent whether all features/sub-features are loaded and active at the end appliance, or the end appliance relies on its server at a level “up” the feature manager hierarchy for one or more of the sub-features.

Third, the PC feature manager may determine that the end appliance does not have the capability to receive any of the requested sub-features or the entire feature itself. In that case, the PC feature manager communicates to the end appliance feature manager that use of the feature requires reliance on the PC feature manager, because the end appliance does not have the capability to accept the feature/sub-feature(s). The PC feature manager thus sends a mapping to the end appliance feature manager for use of the feature, and activates that feature (if the feature was not already active) (step 860). Again, although the feature is not sent to the end appliance, and the end appliance instead relies on a mapping provided by the PC feature manager, these actions are transparent to the individual using the feature.

In one embodiment, when a server receives a feature request from one client, and successfully provides the feature to the client in one of the ways described above, the server feature manager reviews its proxiworld knowledge table and targets other clients the server feature manager determines should have the feature as well. The server feature manager then follows the steps described above to provide the feature to the other targeted clients. For example, a PC, such as the PC 140 illustrated in FIG. 2, receives a request for an MP3 player from the PDA 100. After delivering this feature to the PDA 100, the PC feature manager determines that other clients, such as the television 110, clock radio 120, and stereo 130 should have the MP3 player feature as well. The PC 140 feature manager then initiates the process of providing that feature to each of the targeted clients.

Referring back to FIGS. 8A-B, if the feature requested is not available locally to the PC feature manager, the PC feature manager determines if it has any of the sub-features that make up the feature available locally. The PC feature manager then sends a request for the necessary feature/sub-feature(s) to the next level “up” the feature manager hierarchy, which, as illustrated in FIGS. 8A-B, is directed to the universal server (step 865). Again, this request is based on the PC feature manager's search for any sub-features that make up the requested feature.

The feature manager system is not limited to a component hierarchy of just end appliances, PCs and the universal server, as illustrated in FIGS. 8A-B. Other levels may exist within the hierarchy. For example, if a PC feature manager determines that it does not have the requested feature available locally, in another embodiment, the request for the feature to the next level “up” the feature manager hierarchy would be to a LAN server, such as the LAN server 150 illustrated in FIG. 2. This LAN server acts as a server to the PC (i.e., the client) in the feature manager hierarchy. The LAN server feature manager makes identical decisions as the PC feature manager regarding searching for the feature locally, evaluating the capability of the PC to accept the feature or sub-features, and either sending some or all of the sub-features that make up the requested feature based on these evaluations, or providing a mapping to the requesting level. Further communication between the feature manager receiving the request and lower levels will become clear in connection with the universal server process described below.

The universal server receives the request and determines if the requested feature is available locally (step 870). Since the universal server is at the top of the feature manager hierarchy, the feature either is available here, or is not available anywhere in the system. For example, any feature that exists at any level below the universal server means that the feature is available at the universal server. Similarly, any feature that exists with any client automatically exists with its direct server and all servers at every level “up” in the feature manager hierarchy. The universal server feature manager reviews its resource file registry to determine if the requested feature exists locally. If the feature does not exist locally, then the feature is not available anywhere in the system and the universal server feature manager notifies the feature manager at the next level down (i.e., the PC feature manager) that the feature is not available (step 872). If the feature request originally came from the end appliance, the PC feature manager, after learning that the feature is not available from the universal server feature manager, notifies the end appliance feature manager that the feature is not available. Thus, in one embodiment, when a feature is not available at the universal server level, each feature manager within the request chain communicates “down,” level by level in the feature manager hierarchy, until the requesting feature manager is notified.

If the feature is found locally by the universal server feature manager, the universal server feature manager evaluates the PC record in its proxiworld knowledge table to determine if the PC has the processing capability, memory or appropriate operating system to receive some or all of the requested features/sub-features (step 880). Again, if multiple versions of the same requested feature are found by the universal server, the universal server feature manager determines which version to send based on the capability of the requesting component and any request restrictions.

After the universal server feature manager completes this capability evaluation, it generally proceeds in one of three ways. First, if the universal server feature manager determines that the PC has the capability to receive, activate and use the necessary feature/sub-feature(s) necessary to fulfill the request, the universal server feature manager retrieves the necessary feature/sub-feature(s) from its local file system (step 885), packages the feature/sub-feature(s) for network transmission and sends to the PC (step 890). Again, in one embodiment, the feature/sub-feature(s) are either encrypted or use a digital signature whenever they are transferred from one component to another in the feature manager system.

Upon receipt of the feature/sub-feature(s), the PC feature manager stores the feature/sub-features locally, and re-initiates the step of determining whether to send the entire feature to the end appliance, or perform other actions as described above in connection with step 835.

Second, the universal server feature manager may determine that the PC only has the capability to receive certain sub-features requested, but not all sub-features requested. In that case, the universal server feature manager retrieves the sub-features the PC has the capability to accept and use from the universal server local file system (step 892), packages the sub-features for network transmission and sends to the PC. The universal server feature manager also communicates to the PC feature manager that use of the requested feature requires coordination with the universal server feature manager, because the PC does not have the capability to accept or use the requested feature/sub-feature(s) by itself. The universal server feature manager notifies the PC feature manager of mappings for sub-features not being sent to the PC. Also, the universal server feature manager activates those sub-features that the PC feature manager receives a mapping for (if those sub-features were not already active) (step 894).

Depending upon the sub-features received by the PC feature manager, the PC feature manager stores those sub-features locally, re-initiates the step of determining whether to send any of these sub-features “down” to the end appliance, and coordinates between the end appliance feature manager and the universal server feature manager for the appropriate sub-features necessary to fulfill the feature request.

For example, an end appliance, such as the PDA 100 illustrated in FIG. 2, may request an MP3 player feature from the PC that acts as its server. If the PC does not have the MP3 player feature stored locally, in the embodiment illustrated in FIGS. 8A-B, the PC requests the feature from the universal server. The universal server may have the feature (comprised of an MP3 decoder sub-feature and a PCM player sub-feature) stored locally, but after evaluating the PC record in the proxiworld knowledge table, the universal server feature manager determines that the PC only has the capability to accept the PCM player sub-feature. The universal server feature manager transfers the PCM player sub-feature to the PC, but not the PCM decoder. The PC feature manager may then determine that the PDA 100 does not have the capability to accept the PCM player sub-feature. However, the PDA 100 can use the MP3 player feature based on the mapping between the PDA feature manager and the PC feature manager for the PCM player, and the mapping between the PDA feature manager, PC feature manager and universal server feature manager for the MP3 decoder. Again, such mapping is transparent to the operator of the PDA who uses the feature requested.

Third, the universal server feature manager may determine that the PC does not have the capability to receive any of the requested sub-features or the entire feature itself. In that case, the universal server feature manager communicates to the PC feature manager that use of the feature requires reliance on the universal server feature manager, because the PC does not have the capability to accept the feature/sub-feature(s). The universal server feature manager thus sends a mapping to the PC feature manager for use of the feature, and activates that feature (if the feature is not already active) (step 882). The mapping is then passed on by the PC feature manager to the end appliance feature manager.

### Mapping Process

A method and system for mapping data in one format to data in another format is provided. The system in one embodiment provides (1) a conversion system for dynamically identifying a sequence of routines for converting data in a source format into data in a target format and (2) a switchboard component for specifying a sequence of conversion routines for converting data in a source format into a target format and for routing the data. The system routes data through the sequence of routines to effect the conversion of the data to the target format or to effect the routing of the data to a target (e.g., display device or disk). The switchboard component allows a user to direct data in a certain source format to a target using a caching mechanism of the conversion system. When a user indicates to route data in that source format to the target, the system stores in a cache an indication of a sequence of routines that are to be invoked to effect the routing. When the conversion system processes data in that format, it retrieves the indication of sequences of routines from the cache and then invokes each routine to effect the routing of the data. To facilitate the use of independently developed conversion routines, the conversion system uses an aliasing scheme for naming data formats. The conversion system allows data formats to be specified as compatible with one another. In this way, even though different naming conventions may be used by different developers of the conversion routines, the conversion system will know what data formats are compatible.

The conversion system inputs data in the source format and identifies a series of conversion routines that can be used to convert the data to the target format. The conversion system dynamically identifies the conversion routines when data in the source format is received. A driver (e.g., an ethernet driver) that receives the data in the source format identifies the first conversion routine and then invokes that first conversion routine passing the data in the source format. The conversion routine converts the data into an output format and notifies a forwarding component of the conversion system. The forwarding component may either know of the target format by having prior knowledge or by receiving notification from the conversion routine, or, alternatively the forwarding component may not know of the target format. If the forwarding component knows of the target format, it can identify a sequence of one or more conversion routines that input data in the output format and that output data in the target format. The conversion system may identify more than one sequence of conversion routines that convert the data to the target format. If the forwarding system does not know the target format, it incrementally identifies the conversion routines in a sequence. Each identified conversion routine when invoked may notify the forwarding component of a target format. The forwarding component may identify multiple conversion routines for converting the data from the output format into another format. Regardless of whether the forwarding component identifies only the next conversion routine in the sequence or identifies all or several of the conversion routines in the sequence, the forwarding component invokes the next conversion routine in the sequence passing the converted data. Each conversion routine converts the data from the output format to another format and then notifies the forwarding component. This process of identifying conversion routines and notifying the forwarding component continues until the data is in the target format or no more conversion routines are available to process the data.

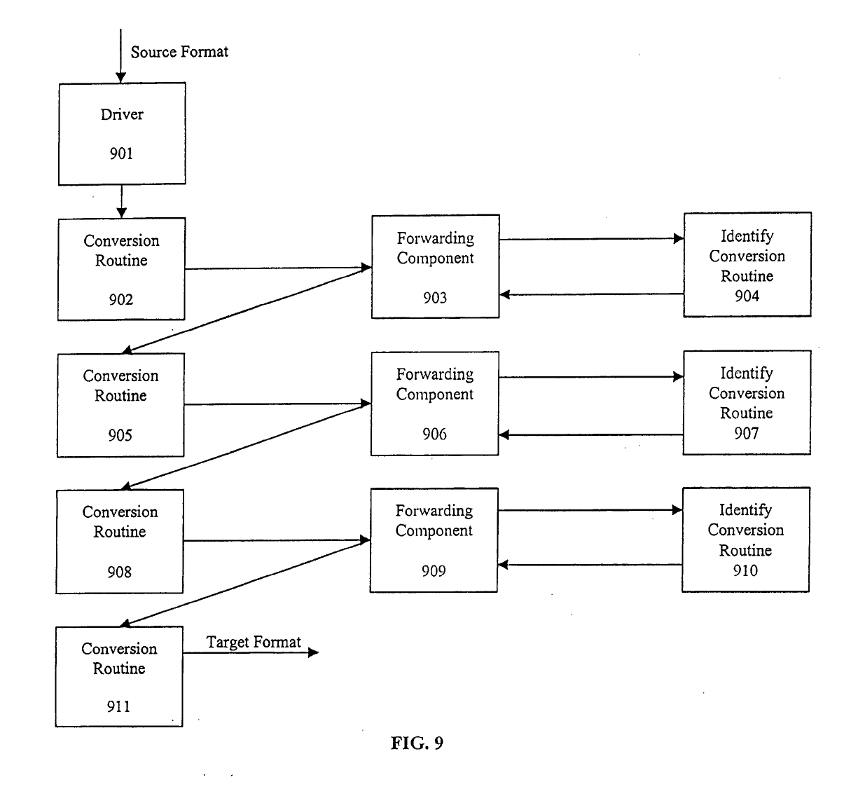

FIG. 9 is a block diagram illustrating the processing of the conversion system of the instant application. Data in the source format is received by driver 901. The driver may convert the data to an intermediate format or perform other processing on the data before invoking conversion routine 902. The conversion routine 902 converts the data to another intermediate format and provides that data to the forwarding component 903. The forwarding component invokes an identify conversion routine component 904 to identify a conversion routine for processing the data in the intermediate format. The identify conversion routine component may identify multiple conversion routines that input data in the intermediate format and if a target format is known may identify one or more sequences of conversion routines. The forwarding component then invokes the identified conversion routines 905 that input data in the intermediate format. Although not illustrated in this figure, a graph of the invocation of conversion routines is a tree-like structure because the forwarding component may invoke multiple conversion routines to process a certain intermediate format. This process is repeated until eventually conversion routine 911 outputs the data in a target format.

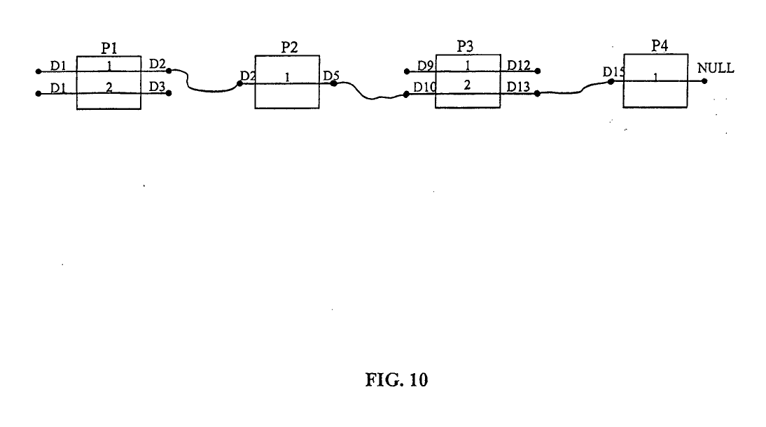

The conversion system identifies a sequence of “edges” for converting data in one format into another format. Each edge corresponds to a conversion routine for converting data from one format to another. Each edge is part of a “protocol” that may include multiple related edges. For example, a protocol may have edges that each convert data in one format into several different formats. Each edge has an input format and an output format. A “path” is a sequence of edges such that the output format of each edge is compatible with the input format of another edge in the sequence, except for the input format of the first edge in the sequence and the output format of the last edge in the sequence. FIG. 10 is a block diagram illustrating a path. Protocol P1 includes an edge for converting format D1 to format D2 and an edge for converting format D1 to format D3; protocol P2 includes an edge for converting format D2 to format D5, and so on. A path for converting format D1 to format D15 is shown by the curved lines and is defined by the address “P1:1, P2:1, P3:2, P4:7.” When a packet of data in format D1 is processed by this path, it is converted to format D15. During the process, the packet of data is sequentially converted to format D2, D5, and D13. The output format of protocol P2, edge 1 (i. e., P2:1) is format D5, but the input format of P3:2 is format D10. The conversion system uses an aliasing mechanism by which two formats, such as D5 and D10 are identified as being compatible. The use of aliasing allows different names of the same format or compatible formats to be correlated. In the following, the term “format” is also referred to as a “data type” or “media type.”

The conversion system may be implemented as a media mapping system that dynamically identifies paths for converting data of one media type to another media type. The media mapping system employs an aliasing scheme that allows different protocols to use different names to refer to the same or compatible media type. For example, a protocol for processing data in the Internet Protocol (“IP”) ₘay output data of media type “IP0x04,” and a protocol for processing data in the Transmission Control Protocol (“TCP”) may input data of media type “TCP.” An administrator of the media mapping system may specify that the “IP0x04” media type is compatible with the “TCP” media type. Thus, the protocol with an edge that inputs the “TCP” media type can process data in the “IP0x04” media type. When the media mapping system receives a source media type and a target media type, it attempts to identify a path for converting the source media type to the target media type.

The media mapping system initially identifies a path by searching for a protocol with an edge whose input media type is compatible with the source media type. The media mapping system then searches for a protocol with an edge whose input media type is compatible with the output media type of the last found protocol. This process is repeated until a protocol is found with an edge that outputs the target media type. This sequence of edges of protocols forms a path. The media mapping system caches the address of the path so that the next time data is to be converted from that source media type to that target media type the path can be quickly identified from the information in the cache without searching for protocols. The media mapping system may also use cached address of paths to convert and route the data based on paths that are pre-configured or that are specified by a user using the switchboard component.

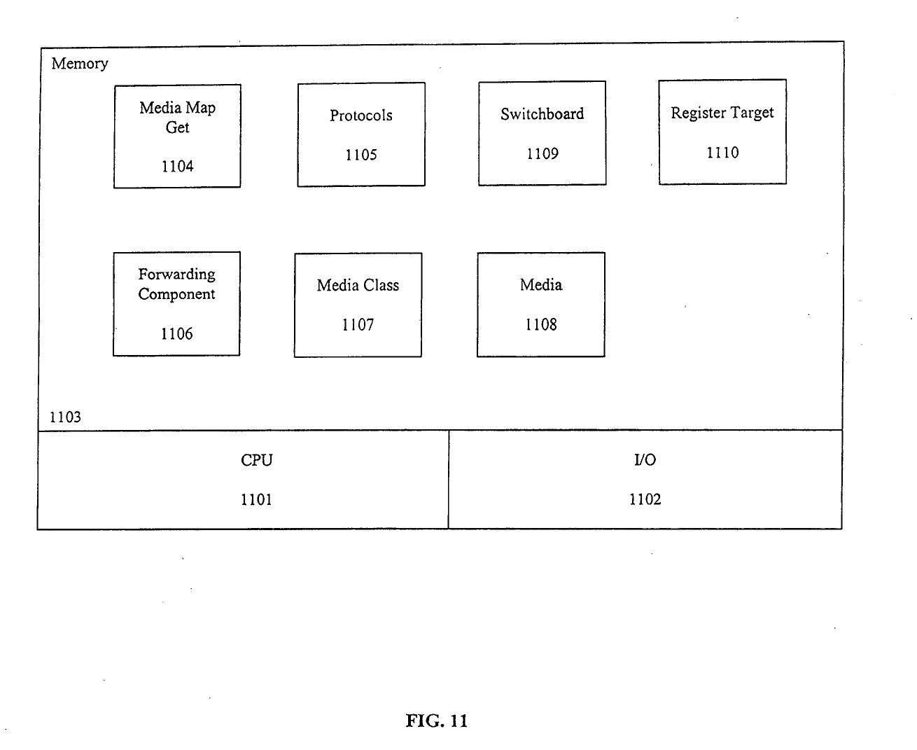

FIG. 11 is a block diagram illustrating components of the media mapping system. The conversion system can operate on a computer system with a central processing unit 1101, I/O devices 1102, and memory 1103. The media mapping system includes a media map get component 1104 that identifies conversion routines, conversion routines referred to as protocols 1105, a forwarding component 1106, media class data 1107, media data 1108, switchboard component 1109, and a register target component 1110. The switchboard component is used to route data of a certain media type to a certain target device. The register target component is used to register the possible target devices for the data. The process of identifying a path either by searching for routines, by receiving a path from another computer, or by another means is referred to as “discovering the path.” The media mapping system may be stored as instructions on a computer-readable medium, such as a disk drive or memory. The data structures of the media mapping system may also be stored on a computer-readable medium. The I/O devices may include an Internet connection, a connection to various output devices such as a television, and a connection to various input devices such as a television receiver.

The conversion system may be used in conjunction with a routing system to route data generated in one format to a certain device. For example, data generated by a program in bitmap format on one computer system may be routed to the display of another computer. The routing system may provide a switchboard component through which a user can route data in one format to a certain target (e.g., device or program). The switchboard component provides a list of source formats that can be generated by or received at the computer system and a list of the possible targets. A user can use the switchboard component to specify that data in a certain source format is to be routed to a certain target or multiple targets. The routing system then sets up the appropriate data structures to ensure that data is routed to the target. In one embodiment, the routing system uses the address of a path to identify the routines that effect the routing of the data. The routing system stores the address in a cache of the conversion system so that the conversion system can route the data of the form based on the path.

Although illustrative embodiments have been described herein in detail, it should be noted and understood that the descriptions have been provided for purposes of illustration only and that other variations both in form and detail can be made thereupon without departing from the spirit and scope of the feature manager system. The terms and expressions have been used as terms of description and not terms of limitation. There is no limitation to use the terms or expressions to exclude any equivalents of ideas shown and described or portions thereof, and the feature manager system should be defined with the claims that follow.

1-26. (canceled)

27. A method of deploying computer code for a feature within a network, comprising:
receiving a request for the code for the feature from a component \within the network;
searching locally for the code for the feature; and
transferring the code for the feature to the component within the network.

28. The method of claim 27, wherein the code for the feature transferred to the component within the network is a mapping.

29. The method of claim 27, wherein the feature comprises separate versions.

30. The method of claim 29, further comprising determining a version of . the code for the feature to transfer to the component within the network.

31. The method of claim 30, wherein determining a version of the code for the feature to transfer to the component within the network is based on a restriction.

32-33. (canceled)

34. A method of deploying computer code for a feature \within a network, comprising:
receiving a request for the code for the feature from a component within the network, wherein the feature comprises at least one sub-feature;
searching locally for the code for the at least one sub-feature; and determining whether the component has capability to process code for any sub-features of the feature.

35. The method of claim 34, further comprising transferring the code for the at least one sub-feature to the component within the network.

36. The method of claim 35, wherein the code for the at least one sub-feature transferred to the component within the network is a mapping.

37. The method of claim 34, further comprising transferring some of the code for sub-features of the feature to the component within the network.

38. The method of claim 37, further comprising transferring code for a mapping to the component within the network.

39. The method of claim 34, wherein capability to process code for any sub-features of the feature is based on a type of processor on the component.

40. The method of claim 34, wherein capability to process code for any sub-features of the feature is based on memory space on the component.

41. The method of claim 34, wherein capability to process code for any sub-features of the feature is based on an operating system on the component.

42. The method of claim 34, wherein the request for the code for the feature includes at least one restriction on the feature.

43. The method of claim 34, wherein the at least one sub-feature comprises separate versions.

44. The method of claim 43, further comprising:
determining a version of the code for the at least one sub-feature to transfer to the component within the network; and
transferring the version of the code for the at least one sub-feature to the component within the network.

45-62. (canceled)

63. A system for deploying computer code for a feature within a network, comprising:
means for receiving a request for the code for the feature from a component within the network;
means for searching locally for the code for the feature; and
means for transferring the code for the feature to the component within the network.

64. The system of claim 63, wherein the feature comprises separate versions.

65. The system of claim 64, further comprising means for determining a version of the code for the feature to transfer to the component within the network.

66. The system of claim 65, wherein the means for determining a version of the code for the feature to transfer to the component within the network is based on a restriction.

67. (canceled)

68. A system for deploying computer code for a feature within a network, comprising:
means for receiving a request for the code for the feature from a component within the network, wherein the feature comprises at least one sub-feature;
means for searching locally for the code for the at least one sub-feature; and
means for determining whether the component has capability to process code for any sub-features of the feature.

69-74. (canceled)

75. An article of manufacture for causing a computer to deploy computer code for a feature within a network, comprising:
means for causing the computer to receive a request for the code for the feature from a component within the network;
means for causing the computer to search locally for the code for the feature; and
means for causing the computer to transfer the code for the feature to the component within the network.

76. (canceled)

77. An article of manufacture for causing a computer to deploy computer code for a feature within a network, comprising:
means for causing the computer to receive a request for the code for the feature from a component within the network, wherein the feature comprises at least one sub-feature;
means for causing the computer to search locally for the code for the at least one sub-feature; and
means for causing the computer to determine whether the component has capability to process code for any sub-features of the feature.

78-83. (canceled)

84. A system for deploying computer code for a feature within a network, the system comprising:
a storage device storing a program;
a processor in communication with the storage device, the processor operative with the program to:
receive a request for the code for the feature from a component within the network;
search locally for the code for the feature; and
transfer the code for the feature to the component within the network.

85. (canceled)

86. A system for deploying computer code for a feature within a network, the system comprising:
a storage device storing a program;
a processor in communication with the storage device, the processor operative with the program to:
receive a request for the code for the feature from a component within the network, wherein the feature comprises at least one sub-feature;
search locally for the code for the at least one sub-feature; and determine whether the component has capability to process code for any sub-features of the feature.

87-89. (canceled)
